(19) United States
(12) Patent Application Publication
(10) Pub. No.: US 2026/0358152 A1
(43) Pub. Date: Nov. 12, 2026

(54) SENSOR MOUNTING DEVICE AND METHOD FOR MOUNTING THE SENSOR MOUNTING DEVICE TO A POWER SEMICONDUCTOR DEVICE

(71) Applicant: Hitachi Energy Ltd, Zürich (CH)

(72) Inventors: Tobias KELLER, Gebenstorf (CH); Dominik TRUESSEL, Bremgarten (CH); Fabian FISCHER, Baden (CH)

(21) Appl. No.: 19/490,792

(22) PCT Filed: Jun. 28, 2023
(86) PCT No.: PCT/EP2023/067648

§ 371 Date: Dec. 5, 2025

(51) Int. Cl. G01D 11/30

(52) U.S. Cl. CPC G01D 11/30

(57) ABSTRACT

Sensor mounting device comprising a device body with a first side surface and an opposing second side surface, wherein a locating structure is located at the first side surface, and at least a sensor location. At least one sensor element is accommodated inside the at least one sensor location. The sensor mounting device further comprises at least one first mounting structure, adapted for mounting the sensor mounting device to a corresponding at least one second mounting structure of a semiconductor power device.

The present disclosure relates to a sensor mounting device, a power semiconductor device and a method for mounting the sensor mounting device to the power semiconductor device.

The supervision of power semiconductor modules for health monitoring, predictive maintenance, or improved reaction in a failure case is getting more and more important. So different physical parameters like chip temperature, input and output current, or applied voltage can be temporarily or regularly monitored during device operation. Especially the monitoring of the output current is an important feature for an improvement of the operation and control of power modules in an application, but also for an improved control of a short circuit failure mode. This monitoring is typically realized by a current sensor, which is located next to the output or AC terminal of a power module or next to the output bus bar in the application. Power modules with integrated current sensors, especially Hall sensors are a further option.

It is an object to attach sensor elements to a power semiconductor device in a simple manner while still enable accurate measurements of the sensor elements.

This object is solved by the features of the independent claims. Advantageous embodiments are indicated in the dependent claims.

Embodiments of the disclosure, for instance as claimed in the independent claims, address the above shortcomings in the art in whole or in part. Further embodiments of the power semiconductor device, the sensor mounting device and of the method for mounting the sensor mounting device to a power semiconductor device are subject matter of the further claims.

There is provided, a sensor mounting device comprising a device body with a first side surface and an opposing second side surface, wherein at least one locating structure is located at the first side surface. The sensor mounting device further comprises at least one sensor location. At least one sensor element is accommodated inside the at least one sensor location. The sensor mounting device further comprises at least one first mounting structure, adapted for mounting the sensor mounting device to a corresponding at least one second mounting structure of a semiconductor power device.

The sensor mounting device provides a simple structure with a sensor element, which is easy to retrofit to an existing power semiconductor device. This makes it easier to use sensor elements for power semiconductor devices. Thus, the setup and the assembly of power semiconductor devices, like power modules is simpler and less expensive.

A further advantage is more flexibility for designing power semiconductor devices, like power modules. It is up to the customer to mount sensor elements to the power modules. A simple assembly is possible with the first mounting structures. The first mounting structure can be fixed permanently or just temporarily to the second mounting structure. Correspondingly, the sensor mounting device is fixed permanently or just temporarily to the power semiconductor device. It is not necessary to build a product with an integrated sensor element on the power semiconductor device and a second product without a sensor element on the power semiconductor device. With a mountable sensor mounting device, parallel manufacturing of two product versions is omitted. This further safes production costs.

Furthermore it is possible to use more than one sensor element to operate multiple power semiconductor devices with one common sensor mounting device.

The locating structure is a recess and/or a groove, but can also be a notch, cut-out or a different deepening or a combination of these deepenings. Alternatively it is a hole, for example a punch-through or a through hole. The locating structure is for example c-shaped, but can have any suitable geometrical shape, like a circular, oval, triangular, squared, rectangular or other polygonal shape. The shape depends on the shape of the sensor element or parts of the sensor element to be located.

The sensor mounting device further comprises at least one first aligning structure. The first aligning structure facilitates the aligning of the sensor mounting device with corresponding or fitting structures of the power semiconductor device.

The first aligning structure can be for example located inside the locating structure or next to the locating structure. Thus, already existing structures of the power semiconductor device can be used as a further aligning structure for an improved mounting. Since the sensor element in the locating structure is located in a defined position due to the first aligning structure, more accurate measurements with the sensor element are possible.

The first aligning structure comprises for example a slot, which can be partially or completely penetrated by a current carrying structure, like a terminal, used as a further aligning structure of the power semiconductor device. Alternatively the first aligning structure is a bedstop, such that at least a part of the power semiconductor device abuts the first aligning structure or the alignment device. Thus, the sensor element is properly aligned with respect to the current carrying structure, like the terminal. The terminal, for example an output terminal of a power module, which is partially or completely penetrating the slot, at least supports the alignment and fixation of the sensor mounting device. Since the sensor element is located near the slot and consequently near the terminal, a more accurate measurement of, for example the output current from the output terminal is possible.

For the locating structure different designs are possible as long as the magnetic core and/or the sensor element fit inside the locating structure. The at least one locating structure is for example c-shaped, particularly a c-shaped recess, but can have any suitable geometrical shape, like a circular, oval, triangular, squared, rectangular or other polygonal shape. Depending on the requirements of the shape of the magnetic core the locating structure, like a recess, can have any suitable shape. The magnetic core comprises a gap and the at least one sensor location is located inside the gap after mounting of the magnetic core. Arranging the at least one sensor location inside the gap makes it possible to have a setup as compact as possible. The magnetic core surrounds for example the at least one first aligning structure. In this certain case, a proper alignment between the terminal and magnetic core is facilitated.

A cap may be provided to protect the magnetic core and the locating structure from dust, debris and other contaminations to ensure as long an operating time as possible without maintenance. The cap may have the same shape as the magnetic core to completely cover the magnetic core.

The device body of the sensor mounting device can be made of any electrically isolating material. The electrically isolating material is especially thermoplastic or thermosetting resin filled with particles or fibers made of inorganic material. These materials are sturdy and easy to process. Additionally, the whole sensor mounting device may be made of an electrically isolating material, like thermoplastic or thermosetting resin filled with particles or fibers. Furthermore the device body comprises a transfer molding component and/or an injection molding component or is made in a transfer molding process and/or injection molding process. Other applicable molding processes are also viable to produce the device body. These are simple method for producing the device body and can also be used for the remainder of the sensor mounting device.

The at least one sensor element is for example a sensor for detection of electrical and/or electro-magnetic and/or magnetic parameters, like electric current, voltage, electric fields, magnetic fields and/or electro-magnetic fields. This list is not exhaustive and the sensor element can refer to any sensor element, which is adapted to measure electrical and/or electro magnetic properties of a device.

The at least one sensor element is exemplarily a Hall sensor and/or a Rogowski coil and/or a fiber optic sensor. Hall sensors can be used for current monitoring in power semiconductor modules, but also other kinds of current sensors like Rogowski coils or fiber optics are applicable. If, for example a Hall sensor is used, the sensor consists of a magnetic core, which surrounds the terminal of the power semiconductor device or a different component, like an output busbar in the application. The magnetic core has a gap, where the sensor element, for example a Hall sensor itself, is located. The sensor element measures the magnetic field being generated by the output current. A combination of the three sensor types is possible to provide more accurate measurements and across different devices.

The sensor mounting device comprises at least one third mounting structure, adapted for mounting the sensor mounting device to a corresponding at least fourth mounting structures of at least one another device. For example, a cooling device and/or assembly printed circuit board. Fixing the sensor mounting device to multiple structures provides a more stable structure overall, which provides an improved mechanical support.

The first, second, third and fourth mounting structures comprise clamps and/or shoulders and/or screws and/or threads and/or glue. The mounting structures can be integrally available fixation structures, like clamps, which are used for mounting and fixation of the sensor mounting device and are fitting to corresponding mounting structures of the power semiconductor device. Alternatively, fixation structures of the sensor mounting device can be different parts, which are fixedly or temporarily available on the sensor mounting device and/or in the power semiconductor device.

The first mounting structure is for example a clamp, which is fixed to the corresponding second mounting structure, which is a shoulder. Alternatively, the first mounting structure and the second mounting structure are fastened in the opposite way. Then, the first mounting structure is a shoulder and the second mounting structure is a clamp. The same applies to the third mounting structure and the fourth mounting structure. The first and the second mounting structure, but also the third and fourth mounting structure correspond to each other. Alternative mounting structures and their counterparts are e.g. screws and threads and/or glue and other adhesives.

The additional sensor mounting device is mounted to the peripheral region of the power semiconductor device, where at least a part of the power terminals, especially the output or AC terminal, are located. On one hand, the sensor mounting device may be fixedly connected e.g. by gluing or permanent clamping or screwing. On the other hand, the fixation by clamping or screwing may facilitate a temporary arrangement of the sensor mounting device.

There is also provided a power semiconductor device. The power semiconductor device comprises a housing body with a third side surface, at least one terminal, wherein the at least one terminal is located at the third side surface. The power semiconductor device further comprises at least one second mounting structure, wherein the at least one second mounting structure is configured to be mounted to a corresponding at least one first mounting structure of a sensor mounting device. The power semiconductor device can be any device, which needs monitoring of currents. Typical power devices are IGBT, HEMT, MOSFET, thyristor, diode, which may base on silicon, silicon carbide, gallium nitride. Additionally, the power semiconductor device can incorporate further sensor, control devices, and/or passive devices. Such devices may be arranged on a substrate structure or a control board.

The at least one terminal of the power semiconductor device can be used as a further aligning structure for improving the alignment between the power semiconductor device and the sensor mounting device and thus facilitate a proper alignment between a current carrying structure, like the terminal, and the sensor element.

The realization of an additional sensor mounting device, which can be easily fixed to power semiconductor devices provides a balance between customer requests and the interest of a power semiconductor device manufacturer to keep the complexity of the product and the number of product variants low, which is related to manufacturing costs. So there is a uniform single product without a sensor element, like a Hall sensor, which can be optionally equipped with a sensor element on customer request.

There is also provided a method for mounting the sensor mounting device to a power semiconductor device. The method comprises the steps of providing the sensor mounting device, providing the power semiconductor device and mounting the sensor mounting device to the power semiconductor device, wherein the at least one first mounting structure of the sensor mounting device is fixed to the corresponding at least one second mounting structure of the power semiconductor device.

The method provides a simple mounting of the sensor mounting device to the power semiconductor device to measure currents of the power semiconductor device with the at least one sensor element. The operation of the power semiconductor device is monitored and depending on the measured values, the power semiconductor device can be regulated and controlled to improve performance or detect failure modes.

The method further comprises, aligning the sensor mounting device to the power semiconductor device, wherein the at least one sensor location is located next to a current carrying structure of the power semiconductor device. The alignment of the sensor mounting device to the power semiconductor device also results in an alignment of the at least one sensor element to the current carrying structure, like the terminal, which enables a more precise measurement of electrical, magnetic and electromagnetic properties, like output currents. The current carrying structure is for example used as at least one further aligning structure and fits into the first aligning structure, for example, the current carrying structure partially or completely penetrates the at least one first aligning structure. Alternatively the further aligning structure abuts the at least one first aligning structure or the alignment device. This way the current carrying structure supports the alignment between the sensor mounting device and the power semiconductor device.

The sensor mounting device can also be mounted to at least one another structure, e.g. to a cooling device and/or to an printed circuit board, wherein the at least one third mounting structure of the sensor mounting device is fixed to the corresponding at least one fourth mounting structure of the at least one another structure. The cooling device can be a cooler or a different heat sink, which cools the power semiconductor device during operation to prevent overheating and maintain a stable performance.

The present disclosure comprises several aspects of a power semiconductor device, a sensor mounting device and of a method for mounting the sensor mounting device to the power semiconductor device on the basis of their embodiments and examples. Every feature described with respect to one of the aspects is also disclosed herein with respect to the other aspect, even if the respective feature is not explicitly mentioned in the context of the specific aspect. For example, the method described in this disclosure is directed to a method for mounting the sensor mounting device to the power semiconductor device. Thus, features and advantages described in connection with the power semiconductor device or the sensor mounting device can be used for the method, and vice versa.

While the disclosure is amenable to various modifications and alternative forms, specifics thereof are shown by way of example in the figures and will be described in detail. It should be understood, however, that the intention is not to limit the disclosure to the particular described embodiments and examples. On the contrary, the intention is to cover all modifications, equivalents, and alternatives falling within the scope of the disclosure defined by the appended claims.

The accompanying figures are included to provide a further understanding. In the figures, elements of the same structure and/or functionality may be referenced by the same reference signs. It is to be understood that the embodiments shown in the figures are illustrative representations and are not necessarily drawn to scale.

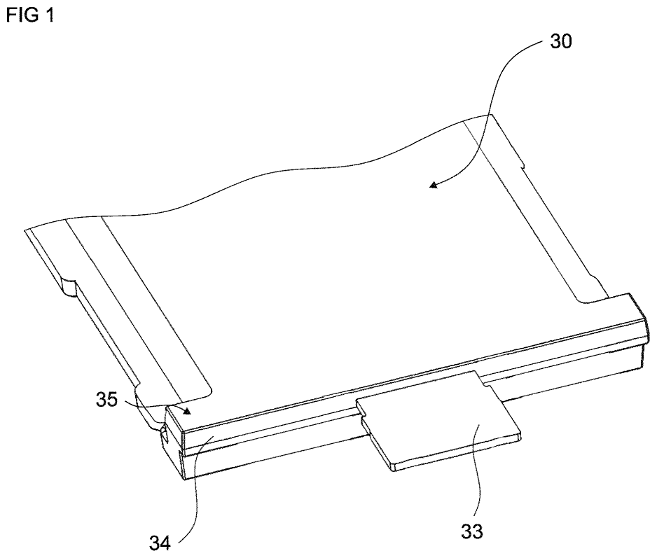

FIG. 1 is a perspective view of a power semiconductor device,

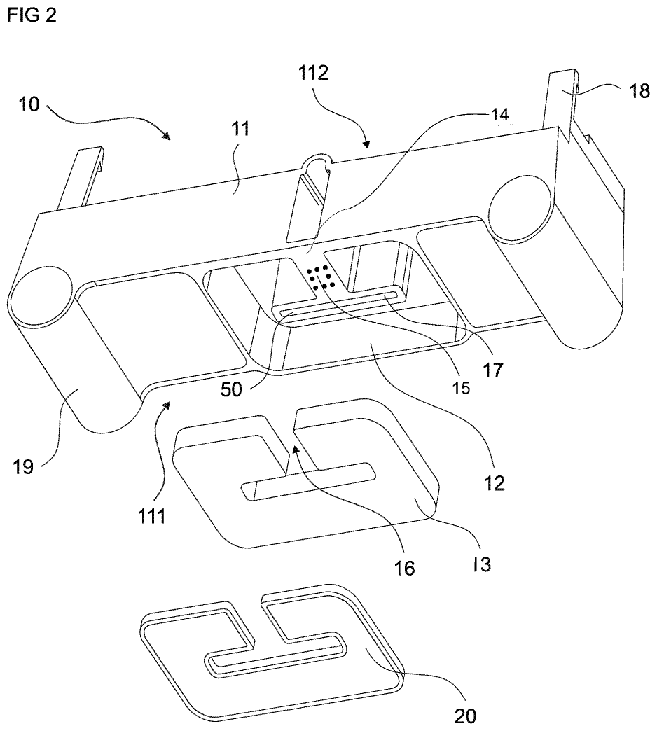

FIG. 2 is a perspective view of a sensor mounting device,

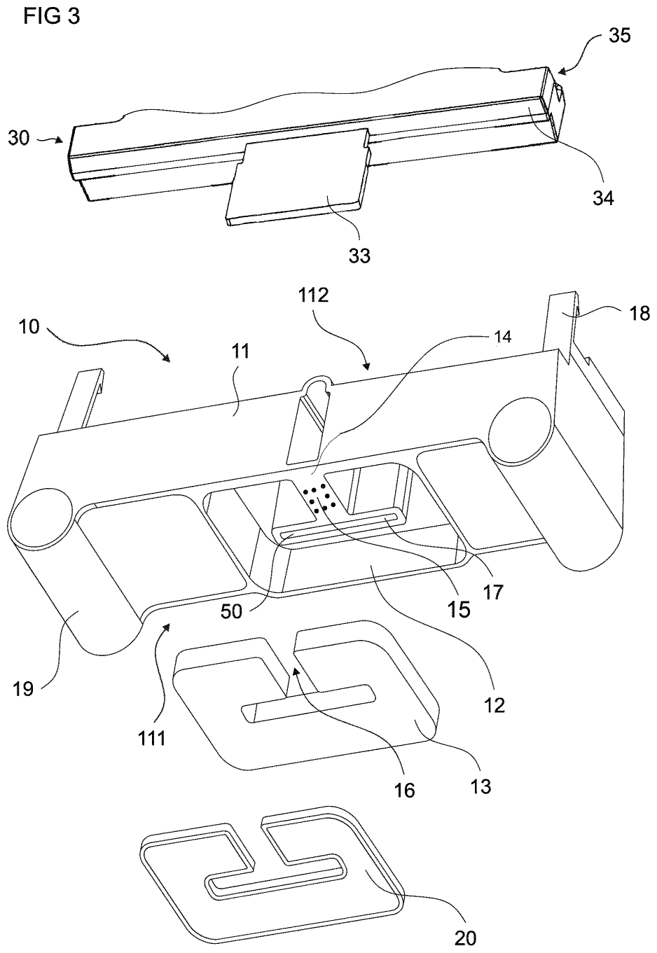

FIG. 3 is a perspective view of the sensor mounting device and the power semiconductor device,

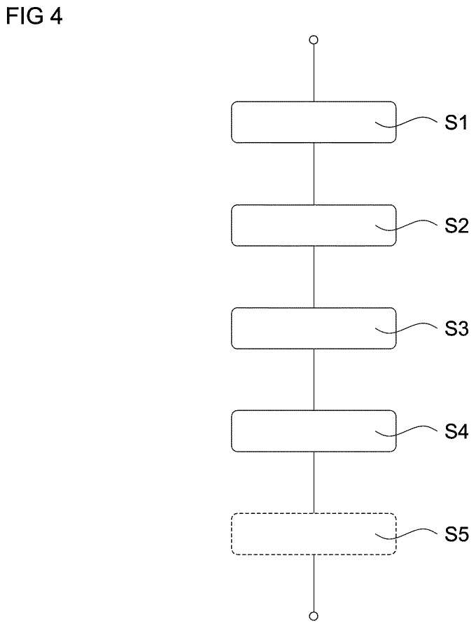

FIG. 4 is a schematic view of the steps of a method for mounting the sensor mounting device to the power semiconductor device.

FIG. 1 shows a perspective view of a power semiconductor device 30. The power semiconductor device 30 comprises at least one terminal 33, which is located at a third side surface 34 of the power semiconductor device 30. Furthermore the power semiconductor device 30 comprises at least one second mounting structure 35, wherein the at least one second mounting structure 35 is configured to be fixed to a corresponding at least one first mounting structure 18 (not shown in FIG. 1) of a sensor mounting device 10 (not shown in FIG. 1). The second mounting structure 35 is a shoulder in FIG. 1, but can also be for example a clamp.

Alternatively the second mounting structure 35 is a screw, a thread and/or glue or other adhesives.

FIG. 2 shows a perspective view of a sensor mounting device 10. The sensor mounting device 10 has a device body 11 with a first side surface 111 and an opposing second side surface 112. The device body 11 can be made of any electrically isolating material. Especially thermoplastic or thermosetting resin material, which is filled by particles or fibers of inorganic material, can be used. The manufacturing of the device body 11 may be done by transfer molding, injection molding, or other applicable molding processes.

A locating structure 12 is located at the first side surface 111 of the device body 11 and is adapted to accommodate a magnetic core 13 and at least one sensor location 14. In this embodiment the locating structure 12 is a recess, but can also be a notch, cut-out, groove or a different deepening. Here, the recess is c-shaped, but can have any suitable geometrical shape, like a circular, oval, triangular, squared, rectangular or other polygonal shape according to the shape of the magnetic core. Here the magnetic core 13 is correspondingly c-shaped and has a gap 16. The sensor location 14 is arranged inside the gap 16 after mounting of the magnetic core 13. The magnetic core 13 is covered by a corresponding c-shaped cap 20 to prevent dust, debris and other pollution to contaminate the magnetic core 13 or the locating structure 12. The magnetic core 13 and the cap 20 can have any suitable geometrical shape fitting to each other, like a circular, oval, triangular, squared, rectangular or other polygonal shape.

Inside the sensor location 14, at least one sensor element 15 is accommodated (in FIG. 2 indicated as dotted square). The device body 11 of the sensor mounting device 10 provides locating structures 12 like recesses for the arrangement of the at least one sensor element 15 and the magnetic core 13. For example, a sensor element 15 can be a current sensor. A current sensor can be any sensor of the type of a Hall sensor and/or a Rogowski coil and/or a fiber optic sensor. Depending on the semiconductor device type or application, the device body 11 may incorporate one current sensor or more than one current sensor, especially three current sensors in the case of a sixpack module. In such an exemplary case each sensor element 15 corresponds to one magnetic core 13. Alternatively one or more sensor elements 15 themselves and the magnetic cores 13 can be integral parts of the sensor mounting device 10.

Inside the locating structure 12 is also a first aligning structure 50, which is adapted for aligning the sensor mounting device 10 with the power semiconductor device 30.

Furthermore the sensor mounting device 10 comprises the at least one first mounting structure 18, adapted for mounting the sensor mounting device 10 to the corresponding at least one second mounting structure 35 of the power semiconductor device 30 (not shown in FIG. 2). In FIG. 2 the first mounting structure 18 is realized as a clamp for a clamped connection with the corresponding second mounting structure 35 (not shown in FIG. 2). Furthermore the sensor mounting device 10 comprises at least one third mounting structure 19, which is adapted for mounting the sensor mounting device 10 to corresponding mounting structures of additional devices, like a cooler, a printed circuit board, like a control board or an assembly board.

FIG. 3 shows a perspective view of the sensor mounting device 10 and the power semiconductor device 30. The sensor mounting device 10 is the same as shown in FIG. 2 and the power semiconductor 30 is the same as shown in FIG. 1 in a partial section. Therefore a detailed description is omitted. The first aligning structure 50, which is a slot 17, can be partially or completely penetrated by at least one further aligning structure, for example by the at least one terminal 33 of the power semiconductor device 30. It is also possible to use different current carrying structures 90 as further aligning structures and corresponding first aligning structures 50.

The first aligning structure 50 can have any geometrical shape as long as it is adapted to be coupled with corresponding features of the power semiconductor device 30 or at least with a part of the power semiconductor device 30, like the at least one terminal 33 protruding from the third side surface 34. This facilitates a proper alignment between the terminal 33 and the magnetic core 13 and consequently with the sensor element 15 (in FIG. 3 indicated as dotted square).

As shown in FIG. 3 the first mounting structure 18 is a clamp, which is fixed to the corresponding second mounting structure 35, which is a shoulder. Alternatively, the first mounting structure 18 and the second mounting structure 35 are fastened in the opposite way. Then, the first mounting structure 18 is a shoulder and the second mounting structure 35 is a clamp.

The sensor mounting device 10 can be attached to only one power semiconductor device 30 as shown in FIG. 3. Alternatively, the sensor mounting device 10 can also be realized as a common device for multiple power semiconductor devices 30 e.g. several equal power modules being arranged in a row on a common baseplate. Here the sensor mounting device 10 can be fixed to the power modules only, but also to corresponding fourth mounting structures 41 (not shown in FIG. 3) of at least one another device, like a cooler, a heatsink or a printed circuit board, like a control board, via at least one third mounting structure 19, which would provide improved mechanical support. The third mounting structure 19 and the fourth mounting structure 41 (not shown in FIG. 3) are as interchangeable as the first mounting structure 18 and the second mounting structure 35.

Alternative mounting structures and their counterparts are screws and threads and/or glue and other adhesives.

If needed, further functionalities or design options can be added to the sensor mounting device 10 like alignment and/or mechanical support features for pin terminals or press-fit terminals and/or pins or bedstops for the positioning of a printed circuit board. For this purpose the sensor mounting device 10 comprises further aligning structures to align the sensor mounting device 10 and the power semiconductor device 30, for example with the printed circuit board. To fix the sensor mounting device 10 to the printed circuit board, the at least one third mounting structure 19 of the sensor mounting devices 10 can be used. Additionally, there may be pins for alignment, which may penetrate into holes of the printed circuit board.

FIG. 4 shows steps of a method of mounting the sensor mounting device 10 to the power semiconductor device 30. In a first step S1 the sensor mounting device 10 is provided. In a second step S2 the power semiconductor device 30 is provided. In a further step S3 the sensor mounting device 10 is aligned to the power semiconductor device 30, wherein at least one current carrying structure 90, like the terminal 33 is used as further aligning structure and partially or completely penetrates the first aligning structure 50. Thus, the sensor element 15 is properly aligned with respect to the terminal 33, which is used as a further aligning structure. The terminal 33, for example an output terminal of a power module, which is partially or completely penetrating the slot 17, at least supports the alignment and fixation of the sensor mounting device 10.

In a step S4 the sensor mounting device 10 is mounted to the power semiconductor device 30, wherein the at least first mounting structure 18 of the sensor mounting device 10 is fixed to the corresponding at least one second mounting structure 35 of the power semiconductor device 30.

In an optional step S5 the sensor mounting device 10 is mounted to the at least one another device, wherein the at least one third mounting structure 19 of the sensor mounting device 10 is fixed to the corresponding at least one fourth mounting structure 41 of the at least one another device. The sensor mounting device 10 can be mounted for example to a cooling device and/or to a printed circuit board. For this purpose the third mounting structure 19 can be used for mounting for example two different devices to the sensor mounting device 10. In this case the cooling device comprises the at least one fourth mounting structure 41 and the printed circuit board comprises at least one fifth mounting structure. The fifth mounting structure comprises also at least one of a clamp, a shoulder, a screw, a thread, glue or another adhesive.

The embodiments shown in the Figures as stated represent exemplary embodiments of the power semiconductor device 30 and of the sensor mounting device 10. Therefore, they do not constitute a complete list of all embodiments according to the improved arrangement for the power semiconductor device 30 or the sensor mounting device 10. Actual arrangements of the power semiconductor device 30 or the sensor mounting device 10 may vary from the exemplary embodiments described above.

### REFERENCE SIGNS

10 sensor mounting device
11 device body
111 first side surface
112 second side surface
12 locating structure
13 magnetic core
14 sensor location
15 sensor element
16 gap of magnetic core
17 slot
18 first mounting structure
19 third mounting structure
20 cap
30 power semiconductor device
33 terminal
34 third side surface
35 second mounting structure
41 fourth mounting structure
50 first aligning structure
90 current carrying structure

1. A sensor mounting device comprising
a device body with a first side surface and an opposing second side surface, wherein
at least one locating structure is located at the first side surface,
at least one sensor location accommodated inside the locating structure, wherein
at least one sensor element is accommodated inside the at least one sensor location,
at least one first aligning structure adapted to be coupled with corresponding features of a power semiconductor device, such that the sensor mounting device is aligned to the power semiconductor device, wherein the at least one first aligning structure comprises a slot, wherein the slot located inside the locating structure and adapted to be penetrated by a current carrying structure of the power semiconductor device, and such that
the sensor element is aligned with respect to the current carrying structure of the semiconductor device, and
at least one first mounting structure located at the second side surface, adapted for mounting the sensor mounting device to a corresponding at least one second mounting structure of the semiconductor power device.

2. The sensor mounting device according to claim 1, wherein the locating structure is a recess and/or a groove.

3. The sensor mounting device according to claim 1, wherein the at least one first aligning structure is accommodated inside or next to the at least one locating structure.

4. The sensor mounting device according to claim 1, wherein a magnetic core is accommodated inside the at least one locating structure.

5. The sensor mounting device according to claim 4, wherein the magnetic core surrounds the at least one first aligning structure.

6. The sensor mounting device according to claim 4 1, wherein the magnetic core comprises a gap and wherein the at least one sensor location is located in the gap.

7. The sensor mounting device according to claim 1, wherein the device body comprises an electrically isolating material, which comprises a transfer molding component and/or an injection molding component.

8. The sensor mounting device according to claim 1, wherein the at least one sensor element is a sensor for detection of electrical and/or electro-magnetic and/or magnetic parameters.

9. The sensor mounting device according to claim 1, wherein the at least one sensor element is a sensor for detection of electric current.

10. The sensor mounting device according to claim 1, wherein the at least one sensor element is a Hall sensor and/or a Rogowski coil and/or a fiber optic sensor.

11. The sensor mounting device according to claim 1, comprising at least one third mounting structure, adapted for mounting the sensor mounting device to a corresponding at least one fourth mounting structure of at least one another device.

12. The sensor mounting device according to claim 1, wherein the at least one first and/or third mounting structure comprise at least one of a clamp, a shoulder, a screw, a thread, glue or another adhesive.

13. A method for mounting the sensor mounting device according to claim 1 to the power semiconductor device, comprising the steps of
providing the sensor mounting device,
providing the power semiconductor device,
aligning the sensor mounting device to the power semiconductor device, wherein the at least one sensor location is located next to a current carrying structure of the power semiconductor device,
mounting the sensor mounting device to the power semiconductor device, wherein the at least first mounting structure of the sensor mounting device is fixed to the corresponding at least one second mounting structure of the power semiconductor device, wherein
the sensor mounting device comprises the at least one first aligning structure comprising the slot, wherein the slot located inside the locating structure and adapted to be penetrated by the current carrying structure of the power semiconductor device.

14. The method according to claim 13, wherein the aligning of the sensor mounting device to the power semiconductor device is supported by the current carrying structure fitting to the at least one first aligning structure.

15. The method according to claim 13, comprising the step of mounting the sensor mounting device to at least one another structure, wherein the at least one third mounting structure of the sensor mounting device is fixed to a corresponding at least one fourth mounting structure of the at least one another device.

16. (canceled)

17. (canceled)

18. (canceled)

19. (canceled)
